(19) United States
(12) Patent Application Publication
(10) Pub. No.: US 2021/0027098 A1
(43) Pub. Date: Jan. 28, 2021

(54) Weakly Supervised Image Segmentation Via Curriculum Learning

(71) Applicant: Shenzhen Malong Technologies Co., Ltd., Shenzhen City (CN)

(72) Inventors: Weifeng Ge, Shenzhen City (CN); Sheng Guo, Shenzhen City (CN); Weilin Huang, Shenzhen City (CN); Matthew Robert Scott, Shenzhen City (CN)

(21) Appl. No.: 16/525,309

(22) Filed: Jul. 29, 2019

Related U.S. Application Data
(60) Provisional application No. 62/877,296, filed on Jul. 22, 2019.

(51) Int. Cl. G06K 9/62; G06T 7/10; G06T 11/20; G06T 7/73

(52) U.S. Cl. CPC G06K 9/6256; G06K 9/6267; G06K 9/6262; G06T 7/10; G06T 2207/20084; G06T 7/75; G06T 2210/12; G06T 2207/20081; G06T 11/20

(57) ABSTRACT

Weakly supervised instance segmentation refers to the task of training a system to detect object locations and segment instances of the detected objects, where the training data includes only images and image-level labels. This disclosure includes an enhanced pipeline and enhanced training methods that progressively mine pixel-wise labels, when trained via image-level labels. Four cascaded modules are employed, including: a multi-label classification module, an object detection module, an instance refinement module, and instance segmentation module. The modules share a common backbone. The cascaded pipeline is trained alternatively with a curriculum learning strategy which generalizes image level supervision to pixel level supervision, and a post validation training stage, which runs in the inverse order. In the curriculum learning stage, a proposal refinement sub-module is employed to locate object parts and finding key pixels during classification.

### BACKGROUND

Via methods of “strong” supervised machine learning, researchers have demonstrated that some architectures of neural networks (NNs) have the ability to “learn” to recognize some pattern types (or signals thereof) encoded in some input data types. For instance, under strong supervision, a NN may be provided a significant amount training data that is labeled with “ground truths,” which accurately and reliably indicate a classification of a pattern (e.g., visual depiction of an object) encoded in the training data. During supervised training, a model implemented by the NN is employed to analyze the labeled training data. The analysis generates output data (e.g., a feature vector) that indicates the labeled classification, or at least a likelihood thereof. The analysis is compared to the ground truth, and a difference (e.g., a loss or cost) function is computed based on the difference. Via methods of backpropagation, the weights of the model are iteratively adjusted to decrease the difference function. As such, given an adequate volume of accurate and reliable training data, which encodes an adequate variance in the patterns to be recognized, the model's weights may be iteratively adjusted such that the average of the difference function (e.g., summed over a statistically significant portion of the training data) is minimized to an acceptable value. As the weights of the models converge to stable values, the model develops the ability to recognize similar patterns encoded in similar, but yet novel, input data.

In particular, because they can trained to recognize and classify some types of patterns (e.g., visual and latent/hidden features) encoded within image data, deep convolutional neural networks (CNNs) are often deployed in computer vision applications. CNN training data often includes images that are labeled via ground truths, which indicate classifications of one or more objects that are visually depicted in the image encoded in the training image data. Via training with the image-level labeled image data, the CNN learns to classify objects (e.g., a dog) depicted within novel input data, based on identifying features encoded in the image data. Based on the identified features, and for each classifiable object type, the model may determine a likelihood that an instance of the object type is depicted in the image. That is, for some types of objects, conventional CNNs have been demonstrated to learn the task of object classification via image-level labeled training data.

Instance segmentation refers to the task of identifying which specific pixels in the image data contribute to the depiction of an instance of an object. Under strong supervision and for each pixel in a frame of image data, a NN may be trained to determine a value that indicates a likelihood of the pixel being included in (or contributing to) an instance of a depicted object. Conventional CNNs (e.g., conventional decoder-encoder CNNs) may require strong supervision to accomplish instance segmentation. For example, conventional CNNs may require pixel-wise labeled training data (i.e., each pixel of the image data being accurately and reliably labeled as being included in or excluded from each instance of each object depicted in the image) to be trained to classify and segment instances of objects encoded in the data. Because a frame of image data may include hundreds of thousands (or even millions) of pixels, labeling each pixel as being included in or excluded from an instance of an object is manually intensive. Furthermore, given the volume, quality, and variance of training data required to train a conventional instance segmentation model, generating pixel-wise labeled training datasets, of sufficient volume, quality, and variance, may not be practical for all applications. Thus, pixel-wise labeled training data may not be readily available for the strong-supervision required to train conventional instance segmentation models for the task of instance segmentation.

### SUMMARY

The various embodiments herein are directed towards weakly-supervised training methods for instance and/or semantic segmentation of image data. In such weakly-supervised training, the training data includes images that are labeled with image-level labels only. That is, the training data employed in the various weakly-supervised embodiments include images that are labeled with one or more objects depicted within the image, but individual pixels of the data are not labeled as being included or excluded from the depicted objects. More specifically, the various embodiments include systems and methods for training a cascaded arrangement of four neural network (NN) modules for instance segmentation, via weakly-supervised learning. The four modules may be included in an image segmentation engine. The four modules include a multi-label classification module, an object detection module, an instance refinement module, and an instance segmentation module. Each of the four modules may share a common backbone module (e.g., a convolutional neural network CNN) that performs initial analysis (e.g., feature detection) on the image. The output of the common backbone (e.g., a feature vector for the image) may be provided as input to each of the four modules. The backbone module may be included in the instance segmentation engine. Each of the modules may employ a model that is implemented via one or more NNs. The multi-label classification module may implement a multi-label classification (MLC) model. The object detection module may implement an object detection (OD) model. The instance refinement module may implement an instance refine (IR) model. The instance segmentation module may implement an instance segmentation (IS) model. The backbone may implement a backbone model. Training the modules may include a two stage process for iteratively updating the weights of the implemented models. The two-stage training process may include a cascaded pre-training stage and a forwards-backwards curriculum learning stage.

In one embodiment, a set of image-level labeled images is employed to supervise a training of the MLC model. The set of image-level labeled images may include a set of images and corresponding one or more image-level labels for each image included in the set of image. The image-level labels for a particular image of the set of images may indicate one or more objects depicted within the particular image. The set of image-level labeled images may not include and/or exclude pixel-wise labels for the images. Based on a first image (and/or a backbone feature vector for the first image that was generated from the backbone model) of set of image-level labeled images, the MLC model generates a first set of object proposals. The first set of object proposals may include a first set of instance segmentation masks, a first set of object bounding boxes for the first set of instance segmentation masks, and a first set of weights that corresponds to the first set of bounding boxes. The first set of object bounding boxes and the first set of weights may be employed to supervise a training of the OD model. Based on the first image (and/or the backbone feature vector), the OD model generates a second set of object proposals. The second set of object proposals may include a second set of instance segmentation masks, a second set of object bounding boxes for the second set of instance segmentation masks, and a second set of weights that corresponds to the second set of bounding boxes. The second set of instance segmentation masks, the second set of object bounding boxes, and the second set of weights may be employed to supervise a training of the IR model. Based on the first image (and/or the backbone feature vector), the IR model generates a third set of object proposals. The third set of object proposals may include a third set of instance segmentation masks, a third set of object bounding boxes for the third set of instance segmentation masks, and a third set of weights that corresponds to the third set of bounding boxes. The third set of instance segmentation masks, the third set of object bounding boxes, and the third set of weights may be employed to supervise a training of the IS model. Based on the first image (and/or the backbone feature vector), the IS model may generate a fourth set of object proposals. The fourth set of object proposals may include a fourth set of instance segmentation masks, a fourth set of object bounding boxes for the fourth set of instance segmentation masks, and a fourth set of weights that corresponds to the fourth set of bounding boxes. The fourth set of instance segmentation masks may include a final segmentation for the first image. The final instance mask may include a set of pixel-wise labels for the first image.

In one embodiment, the IS model may be employed to generate, based on a second image of the set of image-level labeled images, a fifth set of object proposals for the second image. The fifth set of object proposals may include a fifth set of instance segmentation masks, a fifth set of object bounding boxes, and a fifth set of weights that corresponds to the fifth set of object bounding boxes. The fifth set of instance segmentation masks, the fifth set of object bounding boxes, and the fifth set of weights may be employed to validate the training of the IR model. The IR model may generate a sixth set of object proposals. The sixth set of object proposals may include a sixth set of instance segmentation masks, a sixth set of object bounding boxes, and a sixth set of weights that corresponds to the sixth set of object bounding boxes. The sixth set of instance segmentation masks, the sixth set of object bounding boxes, and the fifth set of weights may be employed to validate the training of the OD model. The OD model may generate a seventh set of object proposals. The seventh set of object proposals may include a seventh set of instance segmentation masks, a seventh set of object bounding boxes, and a seventh set of weights that corresponds to the seventh set of object bounding boxes. The seventh set of object bounding boxes and the fifth set of weights may be employed to validate the training of the OD model. The OD model may generate a seventh set of object proposals. The seventh set of object proposals may include a seventh set of instance segmentation masks, a seventh set of object bounding boxes, and a seventh set of weights that corresponds to the seventh set of object bounding boxes. The seventh set of object bounding boxes and the seventh set of weights may be employed to validate the training of the MLC model. The MLC model may generate an eighth set of object proposals. The eighth set of object proposals may include an eighth set of instance segmentation masks, an eighth set of object bounding boxes, and a eighth set of weights that corresponds to the eighth set of object bounding boxes.

In at least one embodiment, at least a portion of the set of image-level labeled images is employed to pre-train the MLC model. Output form the pre-trained MLC model may be employed to pre-train the OD model. Output form the pre-trained OD model may be employed to pre-train the IR model. Output form the pre-trained IR model may be employed to pre-train the IS model. In still another embodiment, the backbone model is employed to generate a feature vector (e.g., a backbone feature vector) for the first image. The MLC model may employ the feature vector to generate at least a portion of the first set of object proposals. The OD model may employ the feature vector to generate at least a portion of the second set of object proposals. The OR model may employ the feature vector to generate at least a portion of the third set of object proposals. The IS model may employ the feature vector to generate at least a portion of the fourth set of object proposals.

In one embodiment, a proposal calibration model may be employed to generate a set of proposal attention maps based on the first set of object proposals. The proposal calibration model may be employed to generate an instance attention map based on the set of proposal attention maps. The proposal calibration map may be employed to generate the first set of instance segmentation masks based on the instance attention map. In at least one embodiment, a non-maximum suppression algorithm is employed to suppress a subset of the first set of object proposals. The instance attention map may be generated based on the suppressed subset of the first set of object bounding boxes.

### BRIEF DESCRIPTION OF THE DRAWINGS

FIG. 1 illustrates an enhanced image segmentation system implementing various embodiments presented herein.

FIG. 2A schematically illustrates an enhanced pipeline for the forward-learning sub-stage of the forward-backwards learning stage of training.

FIG. 2B schematically illustrates an enhanced pipeline for the backwards-validation sub-stage of the forward-backwards learning stage of training.

FIG. 2C schematically illustrates one non-limiting architecture for an image segmentation backbone.

FIGS. 3A-3B schematically illustrate the architecture of the four modules and details of the forwards-backward learning stage.

FIG. 4A schematically illustrates a generation of an instance attention map based on object proposals.

FIG. 4B schematically illustrates feed forward operations of a classification/proposal dissection sub-module.

FIG. 4C schematically illustrates a refinement of an object proposal based on conditional random fields method.

FIG. 5 illustrates one embodiment of an enhanced process flow for training an image segmentation engine.

FIG. 6 illustrates one embodiment of an enhanced process flow for pre-training an image segmentation engine.

FIG. 7A illustrates one embodiment of an enhanced process flow for forwards-learning of an image segmentation engine.

FIG. 7B illustrates one embodiment of an enhanced process flow for backwards-validation of an image segmentation engine.

FIG. 8 illustrates various examples of instance segmentations performed by the various embodiments

FIG. 9 is a block diagram of an example computing device in which embodiments of the present disclosure may be employed.

### DETAILED DESCRIPTION

As used herein, the term “image-level label,” may refer to a label associated with an image that indicates an object depicted in the image. However, an image-level label may not indicate which pixels of the image data encoding the image are included in and/or contribute to the visualization of the object. For example, an image-level label for an image that depicts a dog, could include “dog.” In at least one embodiment, in addition to indicating a depicted object, an image-level label may indicate a probability or likelihood that the object is depicted in an object. For instance, an image-level label may indicate: “dog=0.9, cat=0.1,” where the associated image depicts either a dog or a cat, but it may not be completely discernable from the image. In this example, a classification method may have determined that there is a 0.9 probability that the depicted object is a dog, and a 0.1 probability that the depicted object is a cat. However, the pixels of the image data that contribute to the visualization of the depicted dog (or cate) cannot be determined directly from the image-level label “dog.” In contrast to image-level labels, “pixel-wise labels,” may include an indication for each pixel in the image data, which depicted object (if any), that the pixel contributes to. Similar to image-level labels, pixel-wise labels may indicate an absolute value (e.g., 0 or 1), or a probabilistic indication (e.g., 0.9) that the pixel contributes to the depicted object.

As used herein, the term “object proposal,” may refer to a data element that indicates at least an approximation location, within an image, of which pixels contribute to the depiction of a classified object within the image. An object proposal may include an “object bounding box,” or simply a “bounding box,” which is a structure, whose boundaries separates pixels who may contribute to the visualization of an object from pixels that are not believed to contribute to the object. An object proposal may include a weight for each bounding box, where the weight indicates a confidence level in the bounding box. An object proposal may include a, instance segmentation mask, which masks the pixels that are believed to contribute to the visualization of the object. An instance segmentation mask may include a set of pixel-wise labels for the image.

As used herein, the term “set” may be employed to refer to an ordered (i.e., sequential) or an unordered (i.e., non-sequential) collection of objects (or elements), such as but not limited to data elements (e.g., a set of image-level labeled images, a set of object proposals, a set of weights, a set of instance segmentation masks, and the like). A set may include N elements, where N is any non-negative integer. That is, a set may include 0, 1, 2, 3, N objects and/or elements, where N is an positive integer with no upper bound. Therefore, as used herein, a set may be a null set (i.e., an empty set), that includes no elements. A set may include only a single element. In other embodiments, a set may include a number of elements that is significantly greater than one, two, or three elements. As used herein, the term “subset,” is a set that is included in another set. A subset may be, but is not required to be, a proper or strict subset of the other set that the subset is included in. That is, if set B is a subset of set A, then in some embodiments, set B is a proper or strict subset of set A. In other embodiments, set B is a subset of set A, but not a proper or a strict subset of set A.

The various embodiments herein are directed towards weakly-supervised training methods for instance and/or semantic segmentation of image data. In such weakly-supervised training, the training data includes images that are labeled with image-level labels only. That is, the training data employed in the various weakly-supervised embodiments include images that are labeled with one or more objects depicted within the image, but individual pixels of the data are not labeled as being included or excluded from the depicted objects. The training data does not include pixel-wise labels. More specifically, the various embodiments include systems and methods for training an image segmentation engine (ISE). An ISE may include a cascaded arrangement of four neural network (NN) modules for instance segmentation, via weakly-supervised learning. The four modules include a multi-label classification module, an object detection module, an instance refinement module, and an instance segmentation module. Each of the four modules may share a common backbone (e.g., a convolutional neural network CNN)) that performs initial analysis (e.g., feature detection) on the image. Thus, the ISE may include a image segmentation backbone, or a backbone module. The output of the common backbone (e.g., a vector encoding features of the image) may be provided as input to each of the four modules. Each of the modules may employ a model that is implemented via one or more NNs. For example, the multi-label classification model may implement a multi-label classification (MLC) model, the object detection module may implement an object detection (OD) model, the instance refinement module may implement an instance refinement (IR) model, and the instance segmentation module may implement an instance segmentation (IS) model. The backbone may implement a backbone model. Training the ISE may include iteratively updating the weights of the various models implemented modules.

Curriculum learning may refer to methods of decomposing a complex task into a plurality of less-complex tasks and/or sub-tasks. The various embodiments may employ curriculum learning by decomposing the task of object segmentation into a cascaded sequence of less complex tasks. The sub-tasks may be sequenced into a curriculum of advancing complexity. In the various embodiments, the task of object segmentation within an image is decomposed into multi-label classification, object detection, and instance segmentation sub-tasks. Ordered by complexity, from least complex to most complex, the tasks may be sequenced as multi-label classification, object detection, and instance segmentation. The four modules are trained to perform the various sub-tasks to varying degree of accuracy and/or precision. As described below, the multi-label classification module may be trained primarily to enable the multi-label classification task, the object detection module may be trained primarily to enable the object detection task, and the instance refinement and instance segmentation modules may be trained primarily to enable the instance segmentation tasks. Thus, the embodiments may be said to employ curriculum learning to the problem of weakly-supervised instance segmentation, via a divide and conquer strategy.

The modules are trained to mine pixel-wise labels (e.g., assign labels to individual pixels) using image-level labeled training images and the supervision of previous training stages. That is, the training may be bootstrapped by employing previous stages of training. The modules are co-trained to successively supervise the training of the consecutive modules. In the various weakly-supervised embodiments, curriculum learning is employed to subdivide the task of instance segmentation such that, based on image-level labeled training data, the cascaded modules are progressively employed to supervise the training of other modules to generate pixel-wise labels.

In various embodiments, the multi-label classification module (or the MLC model) is trained to generate a first (or an initial) object proposal for an image. The first object proposal may include a first (or initial) segmentation of the image (e.g., one or more instance segmentation masks). The first object proposal may additionally include a first set of bounding boxes and a first set of corresponding weights. The initial instance segmentation may include pixel-wise labeled via the initial segmentation. The initial object proposals may employed to supervise the training of the object detection module. The object detection module is trained to refine the initial object proposals and/or the initial segmentation, via generating a class probability map. In various embodiments, a class probability map is derived from a neural network, and provides a probability of likelihood for each pixel in an image, wherein the probability indicates a likelihood (or confidence) that the pixel contributes to a detected object in the image.

The refined segmentation and class attention map are employed to supervise the training of the instance refinement module. In various embodiments, a class attention map aggregates the excitation of a trained neural network, and gives the importance of each pixel that contributes to a corresponding object. The instance refinement module is trained to employ neural network to generate class probability maps for the image and an instance segmentation of the image. The class probability maps and instance segmentation are employed to supervise the training of the instance segmentation module. The instance segmentation module is trained to generate the final segmentation of the image. Thus, the instance segmentation module is strongly-supervised, via the gradually-enhanced supervision provided by each of the other three modules. In some embodiments, the training of the system of modules is bootstrapped by sequencing the training through the modules, starting with the multi-label classification module and ending with the instance segmentation module. Once fully trained, the instance segmentation module may be deployed to provide instance segmentation on novel images. As discussed throughout, the training of the backbone and four modules may be divided into two primary stages: a cascaded pre-training stage and a forwards-backwards curriculum learning stage.

More particularly, in the multi-label classification module, the training images are partitioned and/or subdivided into pieces and grouped into different regions to generate initial object proposals. An object proposal may include a bounding box for the image, where at least a portion of the pixels within the bounding box may be contributing to an object depicted in the image. The initial object proposals may be generated via various supervised or unsupervised object recognition techniques, including but not limited to selective search methods and edge box methods. The pixels included an object proposal are characterized and/or organized by low level statistics to generate object candidates. The multi-label classification module may include a classification branch and a class-wise weight branch. The classification and class-wise weight branches may be provided to a classification sub-module, which performs the multi-label classification. A proposal refinement sub-module of the multi-label classification module is employed to generate locations of objects (e.g., an updated, refined, and/or calibrated object proposal) and assign initial pixel-wise labels to at least a portion of the pixels included in the generated object proposals. As discussed below, the multi-label classification module may generate an object score (e.g., a likelihood and/or confidence score) for each object proposal.

The object locations (object proposals) and object score generated by the multi-label classification module are employed to label the images and supervise the training of the object detection module. The object detection module is trained to detect an object, e.g., generate a bounding box (e.g., an object proposal) for the object. In a non-limiting embodiments, the object detection module may be include a “regions with a CNN” (R-CNN) architecture and/or framework. Thus, the object detection module may be trained via an R-CNN training pipeline (or a variant thereof). The R-CNN pipeline may be a Fast R-CNN pipeline or a Faster R-CNN pipeline. The training pipeline may be a You Only Look Once (YOLO) pipeline. The object proposals generated by the multi-label classification may be of low-confidence and/or inaccurate. Thus, when training the object detection module, the object scores may be employed to weight the confidence of the object proposals generated by the multi-labeled classification module. The object detection module is trained to generate higher confidence object proposals (e.g., object locations) than those generated by the multi-label classification module. The object detection may include a proposal refinement sub-module to generate refined object proposal and label pixels included in the refined object proposals as belonging to the corresponding object. That is, the object detection module may generate an instance mask for each classified object within the image. Similar to the multi-label classification module, the object detection module may generate an object score for each of the object proposals.

The object locations, object scores, and corresponding instance masks generated by the object detection module are employed to train the instance refinement module. The instance refinement module generates a refined object proposal and refined instance masks, as compared to the object proposals and instance masks generated by the object detection module. The instance refinement module may include a Mask R-CNN architecture and/or framework. Thus, the instance refinement module may be trained via a Mask R-CNN pipeline. When training the instance refinement module, the object scores may be employed to weight the confidence of the object proposals generated by the object detection module. The instance masks generated by the object detection module may be based on individual samples. To generate a more complete, accurate, and/or refined instance mask than those based on individual samples, the instance refinement module may include an additional instance segmentation branch (e.g., an instance segmentation sub-module). Under the supervision of the object detection module, the instance refinement module is trained to generate a refined and/or more accurate instance mask, as compared to the instance mask generated by the object detection module.

The instance segmentation module is trained under the strong supervision of the object proposals and instance masks generated by the instance refinement module. The object proposals and instance segmentation masks generated by the instance segmentation module are more accurate and/or precise than those generated by the previous modules. As discussed throughout, after training the sequence of the four modules, the training may be reversed such that the output of the instance segmentation module is employed to validate the training of the previous modules.

The various embodiments include an enhanced training pipeline for weakly supervised instance segmentation. The system of four modules may be trained in an end-to-end manner. In general, the four modules mine, summarize, and rectify the appearance of objects in image data. The enhanced embodiments enable training an image segmentation system employing only image-level labeled training data. That is, the various embodiments do not require pixel-wise labeled training data, and thus the embodiments may be referred to as a weakly-supervised image segmentation system. The proposal calibration sub-module included in the modules employs the classification process of CNN to mine the pixel-wise labels from image-level labels. The proposal calibration sub-module may combine top-down and bottom-up methods are combined to refine object proposals and accurately label pixels within the object proposals.

The various embodiments may apply bottom-up methods, top-down methods, and/or a combination thereof for sub-tasks of multi-label classification, object detection, and/or instance segmentation. The various embodiments may use the sub-task of multi-label classification to generate the object proposals, under weak supervision. Pooling layers within the various NNs may be employed to locate the objects within the image data. Object instances may be extracted and/or identified via selective search methods and/or edge boxes methods. In at least one embodiment, peaks within class activation maps may be detected. These peaks may be propagated through a NN to detect corresponding object proposals. Multiscale combinatorial grouping (MCG) methods may be employed to generate the object proposals.

The various embodiments may employ neural attention methods for classification and segmentation tasks. A neural attention map may be generated by one or more of the modules. The neural attention map may indicate a relationship between the pixels in the image and the neural activations within specific layers of the NN. The various embodiments may employ an extension of layer-wise relevance propagation (LRP) method to infer the relationship between the pixels and the activations of the NN. Regions within the various NN layers that contribute to the classification tasks may be identified via excitation backpropagation (Excitation BP). Gradient-weighted class activation mapping (Grad-CAM) methods and/or network dissection methods may be employed for generating the neural attention maps.

A neural attention map may indicate pixel-wise class probabilities, and thus may be a pixel-wise class probability map. The neural attention map may be generated, in a top-down manner, based on the image-level labels. In the embodiments, a forward network structure may be employed to generate neural attention map. The employment of neural attention maps may provide richer supervision for the object detection and the instance segmentation tasks.

### Example Operating Environment

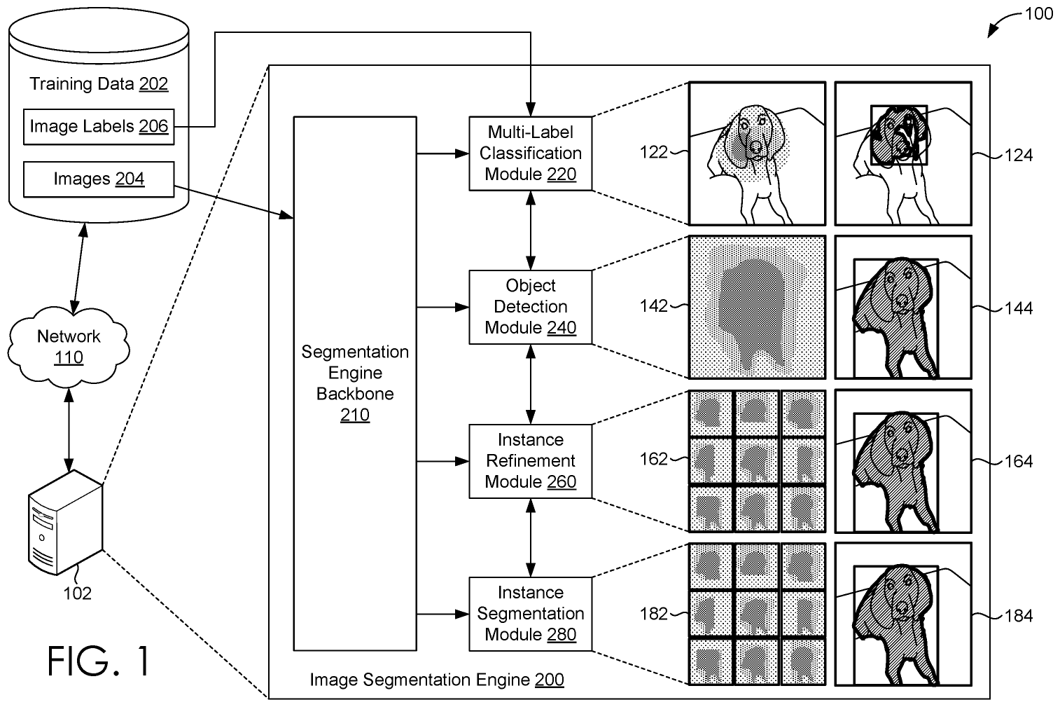

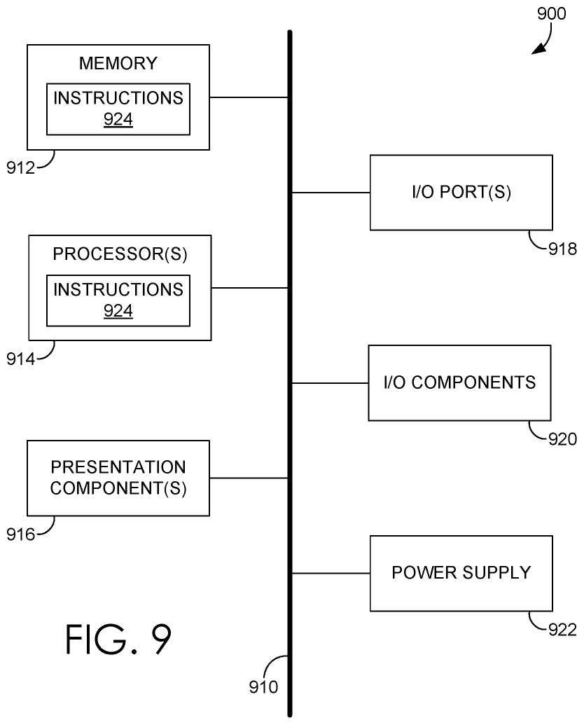

FIG. 1 illustrates an enhanced image segmentation system implementing various embodiments presented herein. System 100 includes one or more various computing devices, such as but not limited to server computing device 102. As shown in FIG. 1, server computing device 102 hosts and/or implements an image segmentation engine 200. As discussed throughout, via weak-supervision, image segmentation engine 200 may be trained to perform object segmentation within images. Other embodiments of system 100 may include additional, alternative, and/or fewer computing devices. An exemplary, but non-limiting embodiment of a computing device is discussed in conjunction with at least computing device 900 of FIG. 9. That is, at least structures, functionalities, or features of computing device 900 may be included in any of computing devices 102 included in system 100.

System 100 may also include a training data repository 202 employed to train the image segmentation engine 200, via weakly-supervised curriculum learning. Training data repository 202 may include one or more image databases, such as but not limited to image database 204. Training data repository 202 may additionally include a image label database 206, which includes image-level labels for the objects depicted within images 204. Thus, images 204 and labels 206 may form a weakly-supervised image-level labeled training dataset for training image segmentation engine 200 for the task of image segmentation. Image database 204 may include millions, or even tens of millions, of instances of images, encoded via image data, and label database 206 may include the corresponding image-level labels for the images. The combination of image database 204 and labels 206 may include a set of image-level labeled images. Labels 206 may include image-level labels for images 204, and exclude pixel-wise labels for images 204. A set of image-level labeled images may comprise a combination of images 204 and labels 206.

A general or specific communication network, such as but not limited to communication network 110, may communicatively couple server computing device 102, training data repository 202, and/or any other computing devices included in system 100. Communication network 110 may be any communication network, including virtually any wired and/or wireless communication technologies, wired and/or wireless communication protocols, and the like. Communication network 110 may be virtually any communication network that communicatively couples a plurality of computing devices and storage devices in such a way as to computing devices to exchange information via communication network 110.

Training data repository 202 may be implemented by a storage device that may include volatile and non-volatile storage of digital data. A storage device may include non-transitory storage media. In some embodiments, training data repository 202 may be stored on a storage device distributed over multiple physical storage devices. Thus, training data repository 202 may be implemented on a virtualized storage device. For instance, one or more “cloud storage” services and/or service providers may provide, implement, and/or enable training data repository 202. A third party may provide such cloud services. Training data, such as but not limited to data used to train image segmentation engine 200, may be temporarily or persistently stored in training data repository 202.

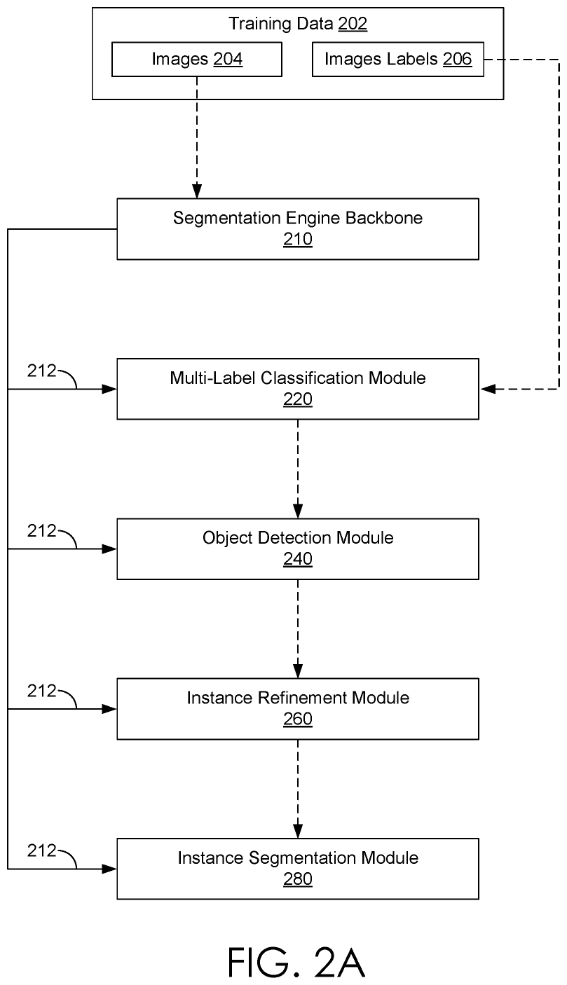

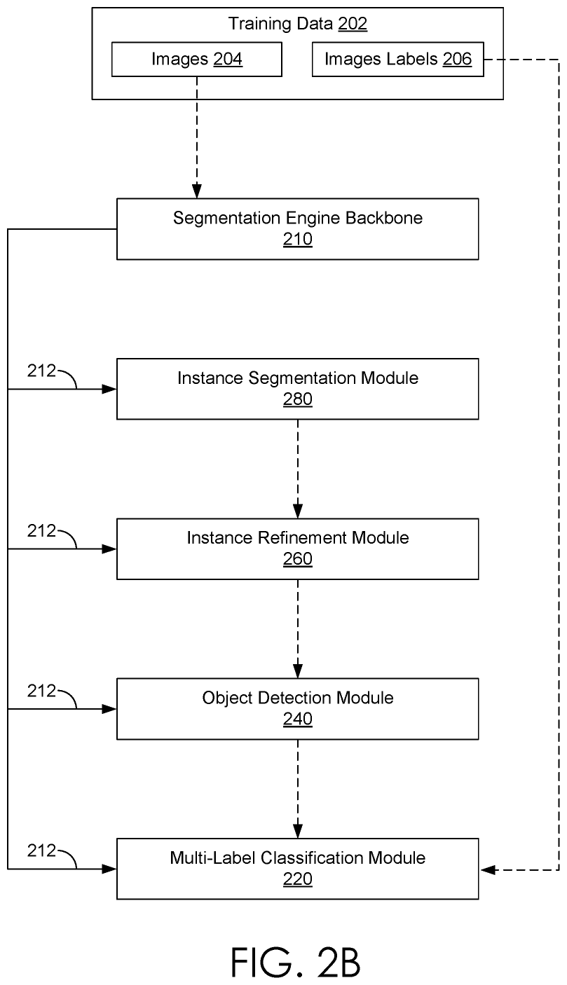

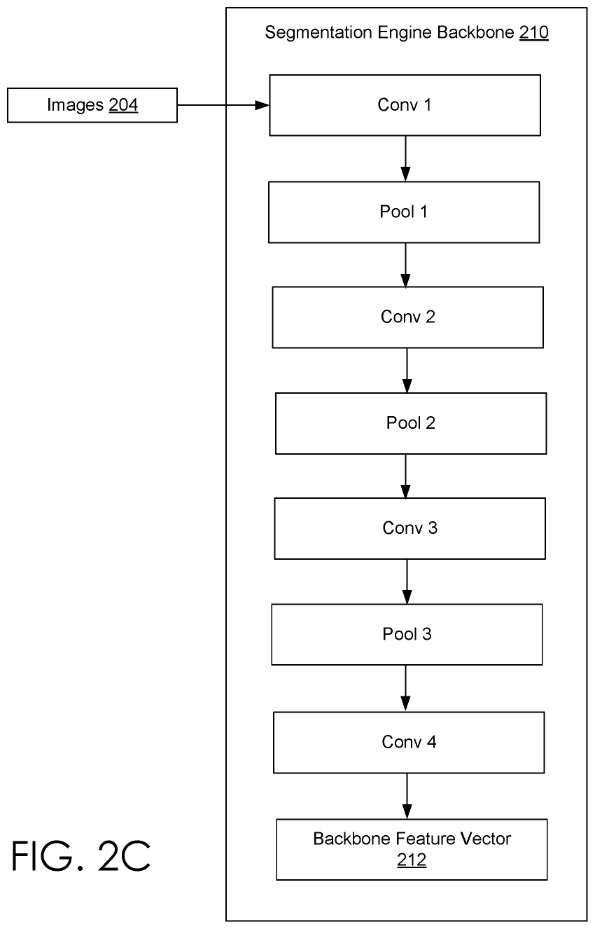

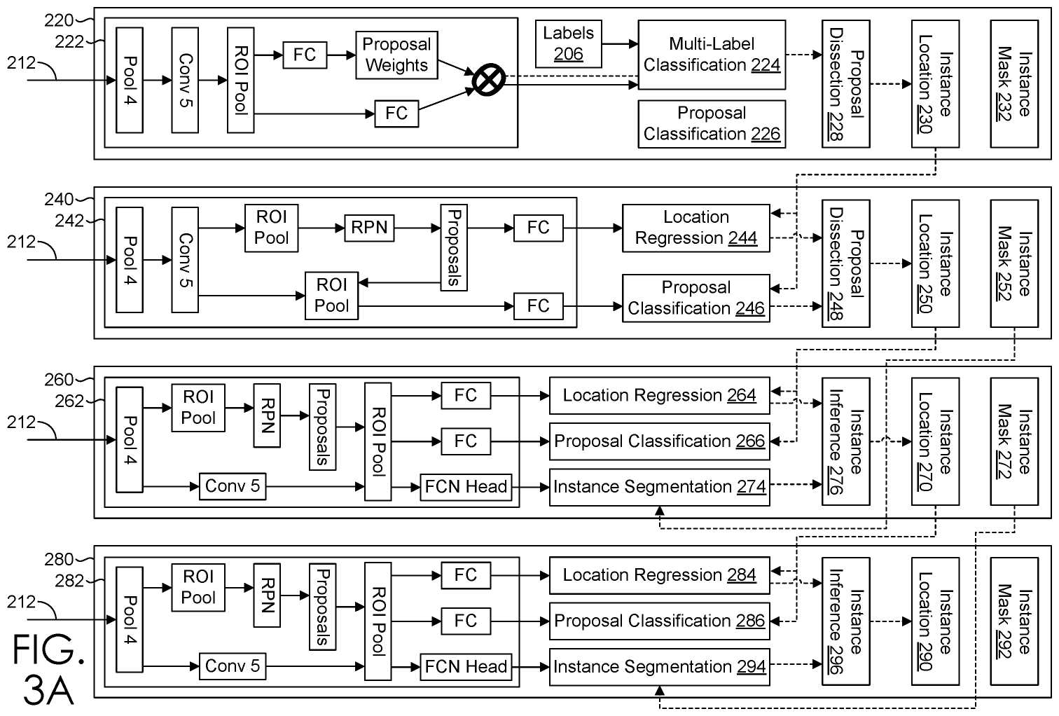

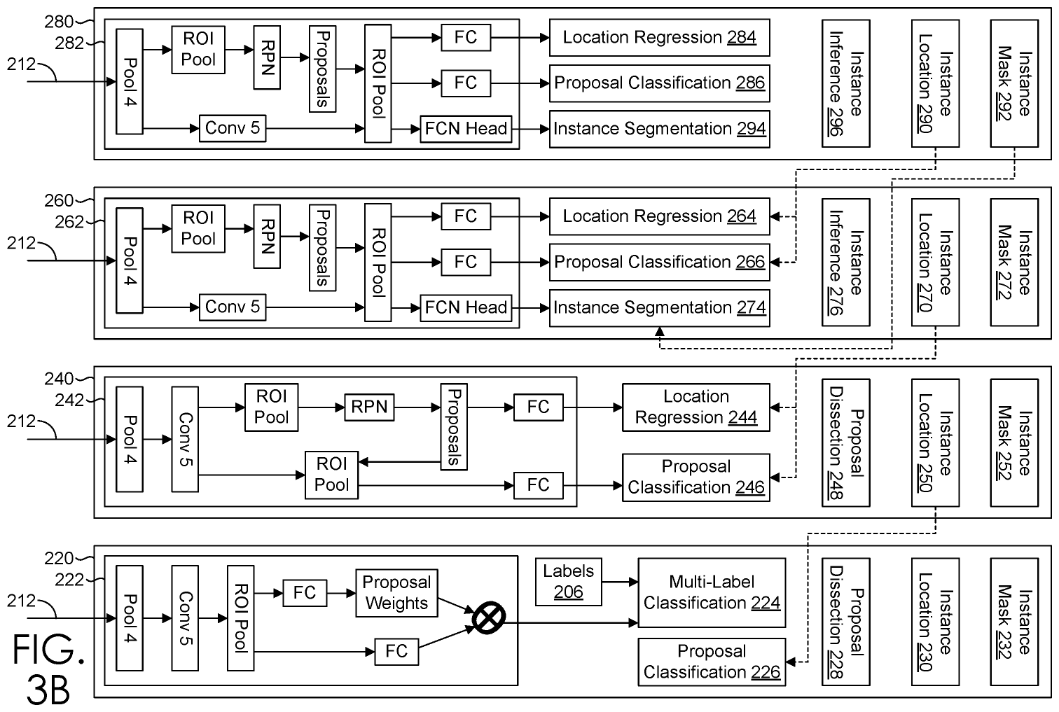

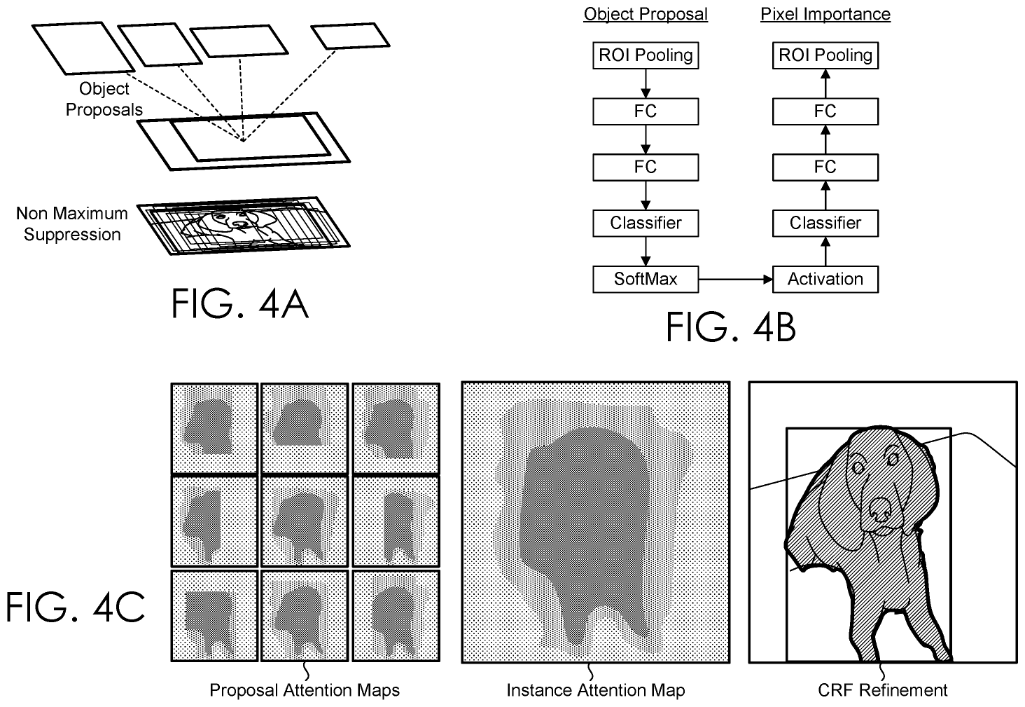

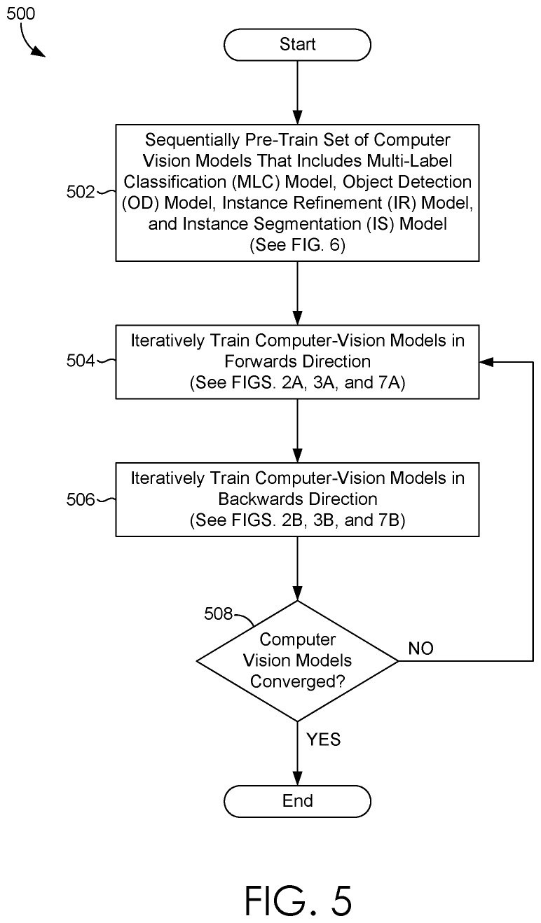

As shown in FIG. 1, instance segmentation engine 200 may include a common segmentation engine backbone 210 and four modules: multi-label classification module 220, object detection module 240, instance refinement module 260, and instance segmentation module 280. The architecture, functionality, and training of image segmentation engine 200 is discussed in conjunction with at least FIGS. 2A-7B. However, briefly here, the four modules 220, 240, 260, and 260 may implement sequential computer vision models for the task of object segmentation within an image. Each of the modules may include one or more neural networks (e.g., a CNN) that implement the sequential computer vision models. For example, the multi-label classification (MLC) module 220 may implement a multi-label classification (MCL) model, the object detection module 240 may implement an object detection (OD) model, the instance refinement module 260 may implement an instance refinement (IR) model, and the instance segmentation module 280 may implement an instance segmentation (IS) model. The segmentation engine backbone 210 (or simply backbone 210) includes one or more NNs (e.g., a CNN). The backbone module 210 may implement a backbone model that is trained to detect features in inputted images (an image from image database 204). The resulting feature vector is provided to each of the four models. In addition to the image's feature vector, the corresponding image-level label (e.g., a corresponding label included in image label database 206) is provided to multi-label classification module 220. The multi-label classification module 220 is trained to classify objects within the image based on the feature vector generated by backbone 210, and generate a class attention map 122 and corresponding initial segmentation 124 of the image. Note that the initial segmentation 124 includes an initial object proposal (e.g., an initial bounding box) for a classified object (e.g., a dog) depicted in the image and an initial segmentation (an initial segmentation mask) of the classified object.

The object detection module 240 is trained to detect objects depicted within the image based on the feature vector generated by backbone 210. Object detection module 240 generates a class attention map 142 and a refined segmentation 144 of the detected object. The refined segmentation 144 includes a refined bounding box and a refined segmentation mask for the dog, as compared to the initial segmentation generated by the multi-labeled classification module 220. Instance refinement module 260 is trained to generate an instance refinement of the segmentation of the object, based on the feature vector generated by the backbone 210. Instance refinement module 260 generates one or more class probability map 162 and an instance segmentation 164 of the detected object. The instance segmentation 164 includes a more refined bounding box for the object and more refined segmentation mask for the dog. The instance segmentation module 280 is trained to generate an even more refined and/or accurate instance segmentation of the object, based on the feature vector generated by the backbone 210. Instance segmentation module 280 generates one or more class probability map 182 and an instance segmentation 184 of the doc, which includes a bounding box and a segmentation mask for the dog.

More particularly, the multi-label classification module 220 is trained to generate an initial segmentation of an image 124. The image may be pixel-wise labeled via the initial segmentation 124 and employed to supervise the training of the object detection module 240. The object detection module 240 is trained to refine the initial segmentation 124, via generating a class attention map 142. The refined segmentation 144 and class attention map 142 are employed to supervise the training of the instance refinement module 260. The instance refinement module 260 is trained to employ neural network attention to generate class probability map 162 for the image and an instance segmentation 164 of the image. The class probability map 182 and instance segmentation 164 are employed to supervise the training of the instance segmentation module 280. The instance segmentation module 280 is trained to generate the final segmentation 184 of the image, via class probability map 182. Thus, the instance segmentation module 280 is strongly-supervised, via the gradually-enhanced supervision provided by each of the other three modules 220, 240, and 260. In some embodiments, the training of engine 200 is bootstrapped by sequencing the training through the modules, starting with the multi-label classification module and ending with the instance segmentation module. Once fully trained, the instance segmentation module 280 may be deployed to provide instance segmentation on novel images. As discussed in conjunction with at least FIGS. 2A-2B the training of the backbone and four modules may be divided into two primary stages: a cascaded pre-training stage and a forwards-backwards curriculum learning stage.

FIG. 2C schematically illustrates one non-limiting architecture for an image segmentation backbone 210 that is consistent with the various embodiments. In various embodiments, the architecture of backbone 210 may be based on and/or similar to the architecture of a VGG16 CNN. The non-limiting embodiment shown in FIG. 2C is based on the first four convolutional stages of a VGG16 CNN. For the cascaded pre-training stage, the parameters of backbone 210 may be initialized from an ImageNet pre-trained model. Backbone 210 nay include multiple pooling layers (e.g., Pool 1, Pool 2, Pool 3, and Pool 4) that are interleaved between multiple convolutional layers (e.g., Cony 1, Cony 2, Cony 3, and Cony 4). FIG. 2C shows backbone 210 receiving image 204 as input, and Cony 4 layer generating the backbone feature vector 212.

Turning now to FIGS. 3A-3B, which schematically illustrate the architecture of the four modules and details of the forwards-backward learning stage, and similar to FIGS. 2A-2B, the direction of the arrows indicate the sequence of the forwards-backwards curriculum learning stage. Solid arrows indicate that backpropagation, via a loss or cost function is employed at the corresponding portion of the training to update the parameters or weights of the models in training. Hashed arrows indicate that backpropagation is not used in the training at the corresponding portion of the training.

Image segmentation engine 200 may be trained, via the forwards-backwards learning stage shown in at least FIGS. 3A-3C, such that given an image I associated with an image level-label label 206 (e.g., image-level label vector y_{l=[y}¹, y², . . . , y^{C}]^{T}) engine 200 generates pixel-wise labels Yₗ=[y₁, y₂, . . . , y_{P}]^{T} for each object instance. C is the number of object classes, P is the number of pixels in I. y¹ is a binary value, where y¹=1 means the image I contains the l-th object category, and otherwise, y¹=0. The label of a pixel p is denoted by a C-dimensional binary vector yₚ. The various embodiments include weakly-supervised training methods for training image segmentation engine for the task of instance segmentation of an image. The various training methods include a divide-and-conquer approach to curriculum learning. The embodiments train the models implemented by the four modules with increasingly stronger supervision which is performed automatically by propagating object information from image-level labels to pixel-level labels via the four cascaded modules: the multi-label classification module 220, the object detection module 240, the instance refinement module 260, and the instance segmentation module 280.

As discussed throughout, the multi-label classification module 220 may implement a multi-label classification (MCL) model, the object detection module 240 may implement an object detection (OD) model, the instance refinement module 260 may implement an instance refinement (IR) model, and the instance segmentation module 280 may implement an instance segmentation (IS) model. The backbone 210 may implement a backbone model. To at least partially implement the MCL model, the multi-label classification module 220 includes various NN layers 222. To at least partially implement the OD model, the object detection module 240 includes various NN layers 242. To at least partially implement the IR model, the instance refinement module 260 includes various NN layers 262. To at least partially implement the IS model, the instance segmentation module 280 includes various NN layers 282.

In addition to the various NN layers 222, the multi-label classification module 220 may include a multi-label classification 224 sub-module, a proposal classification sub-module 226, a proposal dissection sub-module 228, an instance location sub-module 230, and an instance mask sub-module 232. In additional to the various NN layers 242, the object detection module 240 may include a location regression sub-module 244 sub-module, a proposal classification sub-module 246, a proposal dissection sub-module 248, an instance location sub-module 250, and an instance mask sub-module 252. In additional to the various NN layers 262, the instance refinement module 260 may include a location regression sub-module 264, a proposal classification sub-module 266, an instance segmentation sub-module 274, an instance inference sub-module 276, an instance location sub-module 270, and an instance mask sub-module 272.

Via the set of image-level labeled images, the multi-label classification sub-module 224 may be trained to classify objects depicted in an image. As shown in FIGS. 3A-3B, image-level labels 206 may be provided to the multi-label classification sub-module 224 during training. Proposal classification sub-modules 226, 246, 266, and 286 may be employed to classify object proposals. Proposal dissection sub-modules 228 may be employed to perform net dissection on object proposals. Instance location sub-modules 230, 250, 270, and 290 may be a proposal refinement and/or proposal calibration sub-module as discussed below. However, briefly here, the output of the instance location sub-modules 230, 250, 270, and 290 may be a set of object bounding boxes and a corresponding set of weights for the bounding boxes. Thus, a proposal refinement sub-module may output refined and/or calibrated object proposals. Instance masks 232, 252, 272, and 292 may generate one or more instance segmentation masks for an image. Thus, the output of instance masks 232, 252, 272, and/or 292 may be one or more sets instance segmentation masks, which may be employed to generate pixel-wise labels for the image. The combined output of an instance location sub-module and an instance mask sub-module may be a set of object proposals. The location regression sub-modules 244, 264, and/or 284 may perform a regression analysis of object proposals. Instance segmentation modules 274 and 294 may perform the task of instance segmentation.

As shown in FIGS. 3A-3B, the backbone feature vector 212 is provided to each of the four modules. The backbone feature vector 212 is generated by the backbone 210 (not shown in FIGS. 3A-3C) based on an image 204 input. The multi-label classification module 220 generates a set of initial object proposals, as well as corresponding class confident values and proposal weights, based on image-level category labels 206 (e.g., yₗ=1[y¹, y², . . . , y^{C}]^{T}). The initial object proposals may be approximate or of relatively low-confidence. To identify the initial object proposals for the labeled objects depicted in the image, low-level statistics are employed to generate a set of object proposals R=(R₁, R₂, . . . , Rₙ). In some embodiments, one or more selective search methods may be employed to generate the initial object proposals. The initial object proposals are employed as input to the multi-label classification module sub-module 224 for collecting more confident candidates, and learning to identify pixels which play a key role in the classification task.

For a W×H image I, given a deep neural network ϕ_{d}(⋅, ⋅; θ) with convolutional stride of λₛ, a convolution layer (e.g., Conv 5) in NN layers 222 generates convolutional feature maps with a spatial size of H/ [symbol] ₛ×W/ [symbol] ₓ. The convolutional feature maps are employed by the ROI pooling layer in NN layers 222 to determine regional features for each of the initially generated object proposals R, resulting in |R| regional features for image I. The regional features are provided as input to two fully-connected layers (e.g., FC and FC), in NN layers 222 to generate classification results, x^{c,1} ∈ [symbol] ^{|R|xC}, and weight vectors, x^{p,1}∈ [symbol] ^{|R|xC}, for the |R| initial object proposals. The proposal weights indicate the contribution of each proposal to the C categories in image-level multi-label classification. A softmax function may be applied to normalize the weights as:

$${w}_{i j}^{1} = \frac{{e}^{{x}_{i j}^{p , 1}}}{{Σ}_{i = 1}^{\vert R \vert} {e}^{{x}_{i j}^{p , 1}}} ,$$

where wᵢⱼ^{p,1} indicates the weight of the i-th proposal on the j-th class. The weight matrix may be normalized and indicated as: w¹∈ [symbol] ^{|R|xC}. An object score may be generated for each of the initial proposal on different classes based on an element-wise product, x¹=x^{c,1}⊙w^{p,1}. Image-level multi-label classification results (e.g., image-level labels) may be generated, via multi-label classification sub-module 224, by summing over all the object proposals associated to each class, s_{c}¹=Σᵢ₌₁^{|R|}x_{ic}¹. An object score vector for the input image I, s¹=[s₁¹, s₂¹, . . . , s_{C}¹] may be generated. The object score vector may indicated a confidence value for each class. A probability vector \hat{p}¹=[\hat{p}₁¹, \hat{p}₂¹, . . . , \hat{p}_{C}¹] may be generated by applying a softmax function to s¹. The loss function for image-level multi-label classification sub-module 224 may be computed as:

[symbol]

₁(I, y₁)=−Σₖ₌₁^{C}y^{k} log \hat{p}ₖ¹.

As shown in FIGS. 3A-3B, multi-label classification module 220 includes instance location sub-module 230. Instance location sub-module 230 may refine the initial object proposals. Thus, instance location sub-module 230 may be a proposal refinement sub-module. The object proposals, and the classification scores, x^{c,1}, are provided to the proposal refinement sub-module. The proposal refinement sub-module refines the generated proposals, with more accurate predictions, including and object bounding boxes and segmentation masks. The bounding boxes and segmentation masks are provided to the object detection module 240, resulting in stronger and more accurate supervision for forward-learning training of the object detection module 240.

Various details of implementation and operations of the proposal refinement sub-module are discussed in conjunctions with FIGS. 4A-4C. FIG. 4A schematically illustrates a generation of an instance attention map based on object proposals that is consistent with the various embodiments. FIG. 4B schematically illustrates feed forward operations of a classification/proposal dissection sub-module that is consistent with the various embodiments. FIG. 4C schematically illustrates a refinement of an object proposal based on conditional random fields method that is consistent with the various embodiments. More specifically, FIG. 4A shows multiple candidate object proposals for the dog shown in the image. The proposal refinement sub-module may apply a Non-Maximum Suppression (NMS) method to suppress one or more of the candidate object proposals. An instance attention map may be generated based on the one or more suppressed candidate object proposals. In FIG. 4B, an object proposal may be fed forward in the instance location sub-module 230 to determine pixel importance. An excitation backpropagation method may be inversed into a feed forward manner to determine the pixel importance. In FIG. 4C, a proposal attention map is shown for each of the object proposals. The proposal attention maps may be combined (e.g., summed or blended) to generate the instance attention map. A Conditional Random Fields (CRF) method may be applied to generate the CRF refined segmentation, which may include a bounding box and a segmentation mask for the dog.

More specifically, the proposal refinement sub-module may employ one or more excitation backpropagation methods to generate one or more discriminative object-based attention maps based on the predicted image-level class labels. The one or more attention maps may be generated for each object proposal. FIG. 4A shows multiple object proposals for the dog encoded in the image data. The proposal refinement sub-module may include a network architecture that is similar to the proposal classification sub-module 226. In some embodiments, for a particular object proposal Rᵢ, a softmax function may be applied to the corresponding class prediction xᵢ^{c,1}∈ [symbol] ^{C} to generate a normalized vector, x^{c,1}, and predict an object class cᵢ based on a primary component (or largest valued component) of the vector. A class activation vector, aᵢ^{c,1} ∈ [symbol] ^{c}, may be generated based on setting all other elements to 0, except for the cᵢ-th one in w^{c,1}. An excitation backpropagation method may be employed to feed-forward from the classification layer to the ROI pooling layer by using the activation vector, and generate an attention map, Aᵢ, for each proposal (e.g., see FIG. 4B). For the label c in the ground truth (e.g., label 206) of image I (e.g., image 204), an NMS method may be performed to generate an object candidate R^{c} with the highest confidence. For those proposals which are suppressed by R^{c} (via NMS), their corresponding proposal attention maps may be combined or added to the corresponding locations in the image, to generate a class-specific attention map A^{c}. A set of object attention maps of A=[A¹, A², . . . , A^{C}]∈ [symbol] ^{CxHxW}, with a background map, A₀=max(0,1−Σₗ₌₁^{C}y^{l}Aₗ) may be generated.

A CRF method may be employed to segment the object region more accurately from the corresponding attentional maps, resulting in a set of segmentation masks, S¹∈ [symbol] ^{KxHxW}, with corresponding object bounding boxes, B¹∈ [symbol] ^{Kx4}. For each pair of a bounding box and a corresponding segmentation mask, the corresponding classification score in w^{c,1} may be employed as a weight W¹∈ [symbol] ^{K} to supervise the forward-learning training of the object detection module 240.

As shown in FIG. 3A, the generated proposal bounding boxes B¹∈ [symbol] ^{Kx4} and the corresponding weights W¹∈ [symbol] ^{K} are received as training data at the object detection module 240. Object detection module 240 may implement an object detection model, at least partially enabled by NN layers 242. The object detection model may be trained via the supervision of the received output of the multi-label classification module 220 (e.g., B¹∈ [symbol] ^{Kx4} and W¹∈ [symbol] ^{K}), employed as ground truths. In contrast to conventional methods, a learned weight (e.g., W¹∈ [symbol] ^{K}) for each generated proposal is employed as a ground truth during training. In some embodiments, the object detection model may be a Faster RCNN model. As such, positive and negative proposals around a ground truth bounding box may be sampled, and each proposal sampled may have an equivalent weight with the corresponding ground truth. The loss function of region proposal network (RPN) of NN layer 242 may be indicated as:

$${L ( {w}_{i} , {t}_{i} )}_{r p n} = \frac{1}{{N}_{r p n}} {\sum }_{i} {L}_{o b j} ( {w}_{i} , {w}_{i}^{*} ) + λ \frac{1}{{N}_{r p n}} {\sum }_{i} {w}_{i}^{*} {L}_{r e g} ( {t}_{i} , {t}_{i}^{*} )$$

where Nᵣₚₙ is the number of candidate proposals, wᵢ is the predicted object score, tᵢ is the predicted location offset, wᵢ* is the proposal weight, tᵢ* is the pseudo object location, [symbol] is a constant value. L_{obj}, L_{cts}, and L_{reg} are the object or non-object loss, classification loss, and bounding boxes regression loss respectively. For the RCNN part, the loss function may be indicated as:

$${L ( {p}_{i} , {t}_{i} )}_{r c n n} = \frac{1}{{N}_{r c n n}} {\sum }_{i} {w}_{i}^{*} {L}_{c l s} ( {p}_{i} , {p}_{i}^{*} ) + λ \frac{1}{{N}_{r c n n}} {\sum }_{i} {w}_{i}^{*} {L}_{r e g} ( {t}_{i} , {t}_{i}^{*} )$$

where pᵢ is the classification score, and pᵢ* indicates the object class. N_{rcnn} is the number of proposals generated by RPN, and L_{cls} is the classification loss. On the head of Faster-RCNN architecture, a proposal refinement sub-module is implemented (e.g., instance location 250). The proposal refinement sub-module implemented in the object detection module 240 may be similar to the proposal refinement sub-module implemented in the multi-label classification module 220. Thus, the proposal refinement sub-module in the object detection module 240 enables the object detection model to generate dense proposal attention maps. However, in contrast to the proposal refinement sub-module of the multi-label classification module 220, which outputs multiple candidates for each label, the proposal refinement sub-module of the object detection module 240 may generate multiple candidate object proposals for multiple labels. Multiple instance masks, S², with corresponding object bounding boxes, T², and weights, W²∈ [symbol] , may be generated, where [symbol] is the number of object instances detected.

The instance masks S², object bounding boxes T², and weights W²∈ [symbol] generated by the object detection module 240 may be provided to the instance refinement module 260, and employed to supervise the training of the instance refinement module 260. More specifically, the instance refinement module 260 may be trained to perform the task of instance segmentation, via a joint detection branch and mask branch similar to that of Mask R-CNN. Instance refinement module 240 may implement instance inference, rather than proposal refinement, for dense pixel-level prediction, via feed forward inference. The generation of object instances may be trained via a model implemented by the instance refinement module 260 based on collecting part of the information hidden in the results supervision generated by the object detection module 240. More particularly, object instance segmentation may be performed based on the weights W² learned by the object detection module 240. The forward-learning training process may be similar to that of Mask-RCNN.

Similar to the proposal refinement sub-modules, object masks affiliated with the predicted object location may be summed together to generate an instance probability map. CRF methods may be employed to obtain more accurate results of instance segmentation.

In the multi-classification module 220, the fifth convolution layer (e.g., Conv 5) of NN layers 222, may include three separate stages and/or layers: Conv 5_1, Conv 5_2, and Conv_3. Dilations in these three layers may be set to 2. The feature stride [symbol] ₛ at layer relu5_3 may be 8. The ROI pooling layer of NN layers 222 may be added to generate a set of 512×7×7 feature volumes. Full convolutional layers (e.g., FC and FC) may followed. Similar to the backbone, their parameters may be initialized with an ImageNet pre-trained model. The classification branch and the proposal weight branch may be initialized randomly using a Gaussian initializer.

Similar to NN layers 222, the fifth convolutional layer in the NN layers 242 of the object detection module 240 may include three separate stages and/or layers. Similar to multi-label classification module 220, Conv 5_1, Conv 5_2, and Conv 3 in NN layers 242 may be set to 2. The region proposal network (RPN) in NN layers 242 contains three convolutional layers which each may be initialized with Gaussian distributions with 0-mean and standard deviations 0.01. Proposals may be generated to conduct ROI pooling on the feature maps relu5_3. NN layer 242 includes two fully connected layers (FC and FC). After the fully connected layers, there may be the proposal classification branch that is inputted into the proposal classification sub-module 246 and a bounding box regression branch that is provided as input to the location regression sub-module 244.

The instance refinement module 260 and the instance segmentation module 280 may have similar same network architectures. These modules may include an object detection part and an instance segmentation part. The object detection part may be similar to that in object detection module 240. In the RPN and the subsequent ROI pooling may take as input the feature map of the layer pool4 as input not relu5_3. For the instance segmentation part, an atrous spatial pyramid pooling may be generated after layer relu5_3. The dilations in the atrous spatial pyramid pooling layers may be set.

### Two-Stated Enhanced Training of Instance Segmentation Engine

The training of the sequential models of image segmentation engine 200 will now be discussed. As discussed throughout, the embodiments include training image segmentation engine 200, via progressive curriculum learning, that reduces the likelihood that the models avoid local minima in the loss or cost functions in hyperspace employed during training. Thus, the employment of the progressive curriculum learning improves the training of the image segmentation engine 200. Prior to training the multiple sequential models of the image segmentation engine 200, the model implemented by backbone 210 may be initialized. In at least one embodiment, the backbone's 210 model may be initialized to a pre-trained model (e.g., one of ImageNet's pre-trained computer vision model). As noted above, the training is sequentially implemented by sequentially using the output of the previous module as the supervision of the next model, with gradually enhanced supervision. A two-stage training process may be employed, which includes a cascaded pre-training stage and a forward-backward learning stage that employs curriculum learning.

During the cascaded pre-training stage, the initialized parameters (or weights) of the backbone's 210 model may be held constant. The four cascaded modules (i.e., multi-label classification module 220, the object detection module 240, the instance refinement module 260, and the instance segmentation module 280) are pre-trained in a sequence, starting with the multi-label classification module 220 and ending with the instance segmentation module 280. More particularly, the cascaded pre-training begins by training the multi-label classification module 220. Multi-label classification module 220 may be pre-trained via images 204 and corresponding labels 206. Once the pre-training of the model implemented by the multi-label classification module 220 converges to stable parameters, the model's output are regularized and refined, and employed as supervision for the pre-training of object detection module 240. This sequence of training continues, by using the stable parameters of object detection module's 240 model to supervise the pre-training of instance refinement module 260. Likewise, the stable pre-trained parameters of instance refinement module's 260 model are employed to supervise the pre-training of the instance segmentation module 280.

As noted above, during the cascaded pre-training stage, the multi-label classification module 220, the object detection module 240, the instance refinement module 260, and the instance segmentation module 260, are sequentially trained in a forwards direction (or order). The parameters (or weights) of the backbone 210 may be held constant. For purposes of data augmentation, the size and/or resolution of the training images 204 may be resized and/or scaled. In at least one embodiment, five (or more) image scales (e.g., 480, 576, 688, 864, and 1024) may be employed, where the scaling factor indicates the number of pixels in the shorter dimension of the re-scaled image. In at least one embodiment, the longer dimension may be clipped or capped at 1200 pixels. The mini-batch size for stochastic gradient descent (SGD) pre-training backpropagation may be to 2. In some embodiments, the learning rate is set to 0.001 in the first 40000 iterations and then decreased to 0.0001 in the following 10000 iterations. The weight decay may be set to 0.0005, and the momenta may be set to 0.9. These training parameters may be applied to each of the four modules during pre-training. The values listed for the training parameters are not intended to be limiting, and such values may be varied in other embodiments.

For pre-training, when the current module training converges, the pre-training of the next module is started. As noted above, in various non-limiting embodiments, one or more selective search (SS) methods may be employed by the multi-label classification module 220. Such SS methods may generate a plurality of object proposals for each image. In at least one embodiment, a SS method may generate approximately 1600 object proposals per-image. In some embodiments, each of the object detection module 240, the instance refinement module 260, and/or the instance segmentation module may include one or more region proposal networks (RPNs). In pre-training the RPN of the object detection module 240 and/or the instance refinement module 260, multiple scales and/or aspect ratios may be applied to the images. In one non-limiting embodiment, 3 scales and 3 aspect ratios are employed, yielding k=9 anchors at each sliding position. As noted throughout, each of the modules may include one or more region of interest (ROI) pooling sub-modules. The sizes of the convolutional feature map after ROI pooling in a detection branch and a segmentation branch in the various modules may be 7×7 and 14×14 respectively.

After the cascaded pre-training stage is completed, the forward-backward learning stage may be employed to complete the training of image segmentation engine 200. The forward-backward learning stage includes two sub-stages: a forward-learning sub-stage with curriculum learning and a backwards-validation sub-stage. The forward-backward learning stage of training is discussed in the context of FIGS. 2A-2B. FIG. 2A schematically illustrates an enhanced pipeline for the forward-learning sub-stage of the forward-backwards learning stage of training, which is consistent with the various embodiments. FIG. 2B schematically illustrates an enhanced pipeline for the backwards-validation sub-stage of the forward-backwards learning stage of training, which is consistent with the various embodiments. In FIGS. 2A-2B, the direction of the arrows indicate the sequence of the forwards-backwards learning sub-stage. Solid arrows indicate that backpropagation, via a loss or cost function, is employed at the corresponding portion of the training to update the parameters or weights of the models in training. Hashed arrows indicate that backpropagation is not used in the training at the corresponding portion of the training. The architecture of the backbone 210 is discussed in conjunction with at least FIG. 2C. Various implementation training details regarding the forwards-backwards learning stage of the training of image segmentation engine 200 are further discussed in conjunction with at least FIGS. 3A-3B.

In general, during the training of the models implemented by the modules, one or more of the models may converge in a local minima of its loss or cost function, rather than converging to a solution that at least approximates a global minima within the corresponding hyperspace. The forwards-backwards learning training stage of the various embodiments may avoid the models converging in a local minima, and increase the likelihood that each of the models converges to a point in the hyperspace that at least approximates a global minima of the loss function. In the forward-learning sub-stage, curriculum learning is employed. As shown in FIG. 2A, the four modules are trained in a forward sequence, with the supervision being gradually increased in the forward direction. As shown in FIG. 2B, during the backwards-validation sub-stage, training is performed in an inverse order to that of the forward-learning sub-stage. That is the backwards-validation sub-stage begins that the instance segmentation module 280, where the model predicts an instance segmentation (e.g., object locations and segmentation masks). The output of the instance segmentation module 280 is employed to supervise the backwards training of the instance refinement module 260. The instance refinement module 260 provides object locations to supervise the backwards training of the object detection module 240. The output of the object detection module 240 may be employed to supervise the backwards training of the multi-label classification module 220.

Referring to FIG. 2A, the forward-learning training sub-stage begins, with the backbone 210 receiving an image 204 from the training data 202. The backbone 210 generates a backbone feature vector 212 based on the received image 204. The backbone feature vector 212 is provided to each of: multi-label classification module 220, object detection module 240, instance refinement module 260, and instance segmentation module 280. An image label 206, corresponding to the image 204 is provided to the multi-label classification module 220. The output of the multi-label classification module 220, which is based on the backbone feature vector 212 and the image label 206, is employed to supervise the forward training of the object detection module 240. The output of the object detection module 240, which is based on the backbone feature vector 212 and the output of the multi-label classification module 220, is employed to supervise the forward training of the instance refinement module 260. The output of the instance refinement module 260, which is based on the backbone feature vector 212 and the output of the object detection module 240, is employed to supervise the forward training of the instance segmentation module 280.

Referring to FIG. 2B, the reverse-validation training sub-stage begins, with the backbone 210 receiving an image 204 from the training data 202. The backbone 210 generates a backbone feature vector 212 based on the received image 204. The backbone feature vector 212 is provided to each of: multi-label classification module 220, object detection module 240, instance refinement module 260, and instance segmentation module 280. The output of the instance segmentation module 280, which is based on the backbone feature vector 212, is employed to supervise the backwards learning and/or validation of the instance refinement module 260. The output of the instance refinement module 260, which is based on the backbone feature vector 212 and the output of the instance segmentation module 280, is employed to supervise the backwards learning and/or validation of the object detection module 240. The output of object detection module 240, which is based on the backbone feature vector 212 and the output of the instance refinement module 260, is employed to supervise the backwards learning and/or validation of the multi-label classification module 220.

The forward-learning sub-stage with curriculum learning and the backwards-validation sub-stage may be alternated at each iterative stage of the training. One or more NN layers of the modules may include learnable parameters that are trained in an end-to-end manner. The forwards-backwards learning stage may start from the models trained by the cascaded pre-training. The learning rates in the forwards-backwards learning stage may be set at 0.0001 and 80000 (or more) training iterations may be performed. The number of iterations and training parameters may be varied in the various embodiments. During testing of the models, the original size of an input image may be preserved. In the instance segmentation module 280, the image-level labels have been transferred into dense pixel-level labels. The instance segmentation is performed in a fully supervised manner.

### Generalized Processes for Training an Image Segmentation Engine

Processes 500-720 of FIGS. 5-7B, or portions thereof, may be performed and/or executed by any computing device, such as but not limited to server computing devices 102 of FIG. 1, as well as computing device 900 of FIG. 9. Additionally, an image segmentation engine (ISE), such as but not limited to ISE 200 of FIG. 1 may perform and/or execute at least portions of processes 500-720.

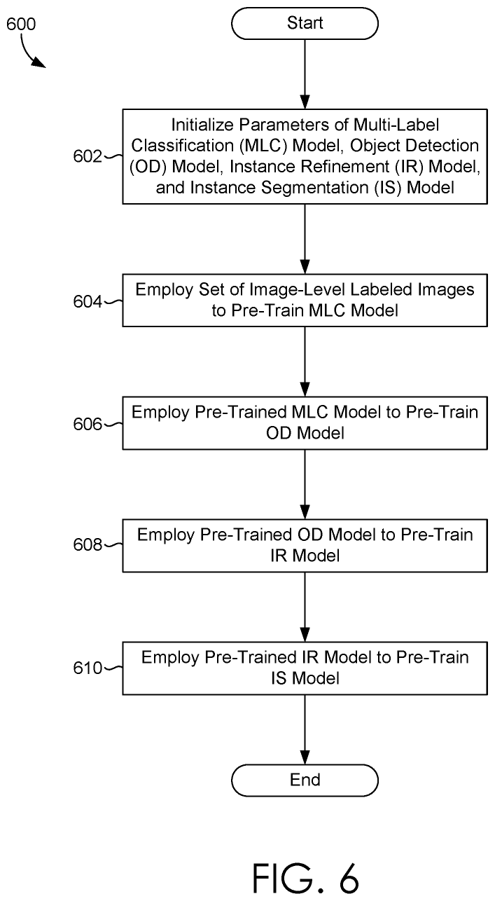

FIG. 5 illustrates one embodiment of an enhanced process 400 flow for training an image segmentation engine (ISE) that is consistent with the various embodiments presented herein. Process 500 begins, after a start block, at block 502, where a set of computer vision models are pre-trained. Various embodiments of pre-training a set of computer models are discussed in conjunction with at least method 600 of FIG. 6. However briefly here, an image segmentation engine (ISE), such as but not limited to image segmentation engine 200 of FIG. 1 implements at least four computer vision models: a multi-label classification (MLC), and object detection (OD) model, an instance refinement (IR) model, and an instance segmentation (IS) model. In one embodiment, the multi-label classification module 220 may implement the MLC model, the object detection module 240 may implement the OD model, the instance refinement module 260 may implement the IR model, and the instance segmentation module 280 may implement the IS model. In some embodiments, the ISE 200 may implement another computer vision model, e.g., a backbone model. Segmentation engine backbone 210 may implement the backbone model. The various computer vision models may be implement via one or more neural networks (NN) as shown in FIGS. 3A-3B. As discussed in conjunction with FIG. 6, at block 502, the various computer vision models may be pre-trained via a cascaded pre-training stage of the ISE 200.

At iterative blocks 504 and 506, the forwards-backwards curriculum learning training stage of the ISE 200 is carried out. More specifically, at block 504, a forwards-learning sub-stage with curriculum learning, and at block 506, the backwards-validation sub-stage is carried out. Via decision block 508, the training sub-stages are iterated over until the models converge. At block 504, the computer vision models are iteratively trained in a forwards direction. Various embodiments of the forwards-learning sub-stage are discussed in conjunction with at least FIGS. 2A, 3A, and FIG. 7A. At block 506, the computer vision models are iteratively trained in a backwards direction. Various embodiments of the backwards-validation sub-stage are discussed in conjunction with at least FIGS. 2B, 3B, and FIG. 7B. Process 600 terminates when the parameters of the models have converged and/or reached an adequate stability in the parameter values.

FIG. 6 illustrates one embodiment of an enhanced process flow 600 for pre-training an image segmentation engine (ISE) that is consistent with the various embodiments presented herein. Method 600 may include initializing the parameters of the backbone model, as well as the MLC model, the OB mode, the IR model, and/or the IS model. In at least one embodiment, the backbone model may be initialized to a pre-trained model (e.g., one of ImageNet's pre-trained computer vision model). As noted above, the training may be sequentially implemented by sequentially employing the output of the previous module as the supervision of the next model, providing gradually enhanced supervision. During method 600 (e.g., the cascaded pre-training stage), the initialized parameters (or weights) of the backbone model may be held constant. The four other cascaded models (i.e., the MLC model as implemented by the multi-label classification module 220, the OD model as implemented by the object detection module 240, the IR model as implemented by the instance refinement module 260, and the IS model as implemented by the instance segmentation module 280) are pre-trained in a sequence, starting with the MLC model and ending with the IS model. More particularly, the cascaded pre-training begins by training the MLC model. MLC model may be pre-trained via images 204 and corresponding labels 206. Once the pre-training of the MLC model implemented by the multi-label classification module 220 converges to stable parameters, the model's output are regularized and refined, and employed as supervision for the pre-training of OD model. This sequence of training continues, by using the stable parameters of OD model to supervise the pre-training of the IR model. Likewise, the stable pre-trained parameters of IR model are employed to supervise the pre-training of the IS model.

As noted above, during the cascaded pre-training stage, the MLC model, the OD model, the IR model, and the IS model are sequentially trained in a forwards direction (or order). The parameters (or weights) of the backbone model may be held constant. For purposes of data augmentation, the size and/or resolution of the training images 204 may be resized and/or scaled. In at least one embodiment, five (or more) image scales (e.g., 480, 576, 688, 864, and 1024) may be employed, where the scaling factor indicates the number of pixels in the shorter dimension of the re-scaled image. In at least one embodiment, the longer dimension may be clipped or capped at 1200 pixels. The mini-batch size for stochastic gradient descent (SGD) pre-training backpropagation may be set to 2. In some embodiments, the learning rate is set to 0.001 in the first 40000 iterations and then decreased to 0.0001 in the following 10000 iterations. The weight decay may be set to 0.0005, and the momenta may be set to 0.9. These training parameters may be applied to each of the four computer vision models during pre-training. The values listed for the training parameters are not intended to be limiting, and such values may be varied in other embodiments.

At block 602, the parameters for the MLC model, the OD model, the IR model, and the IS model may be initialized to one or more pre-trained computer vision models. In at least one embodiment, the parameters of the backbone model may be initialized at block 602. At block 604, at least a portion of a set of image-level labeled images are employed to pre-train the MLC model. At block 606, the pre-trained MLC model is employed to pre-train the OD model. For example, the regularized output of the pre-trained MLC model may be employed to supervise the pre-training of the OD model. At block 608, the pre-trained OD model is employed to pre-train the IR model. For example, the regularized output of the pre-trained OD model may be employed to supervise the pre-training of the IR model. At block 610, the pre-trained IR model is employed to pre-train the IS model. For example, the regularized output of the pre-trained IR model may be employed to supervise the pre-training of the IS model.

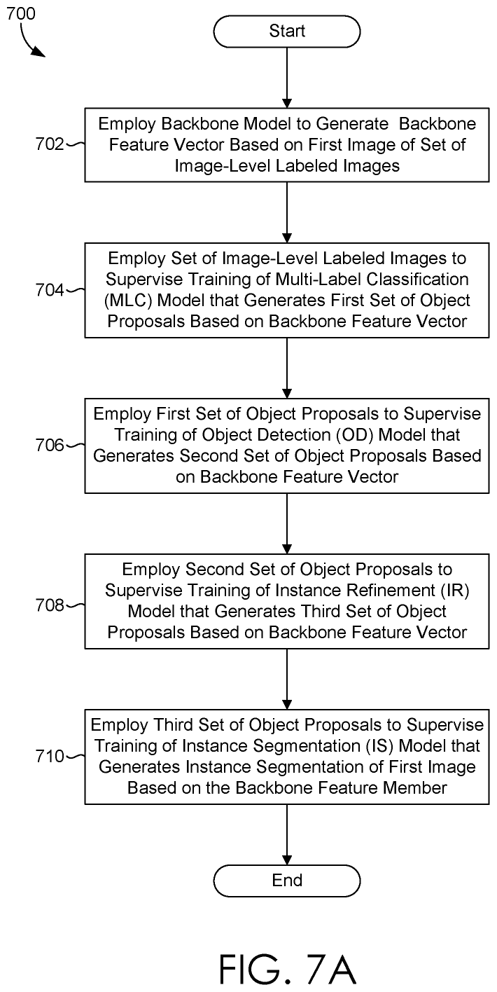

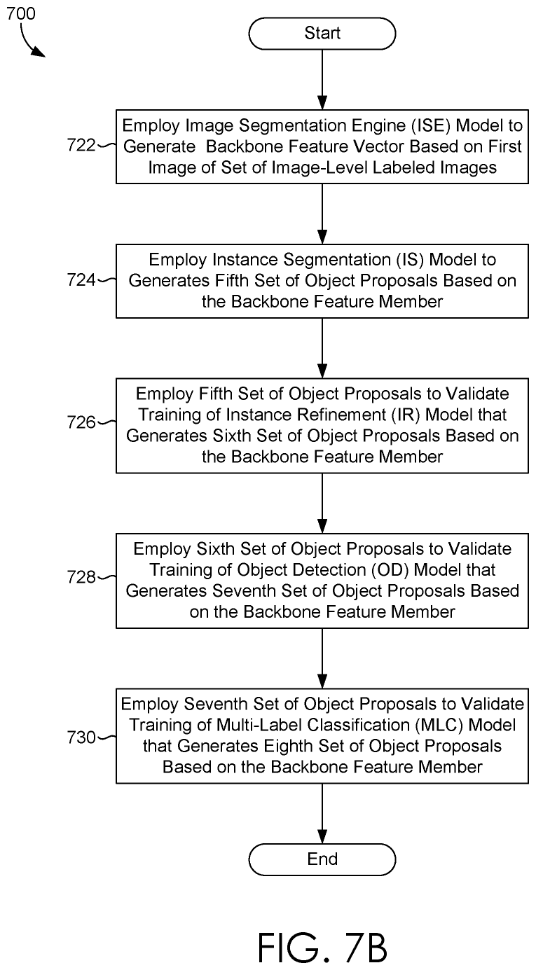

FIG. 7A illustrates one embodiment of an enhanced process flow for forwards-learning of an image segmentation engine (ISE) 200 that is consistent with the various embodiments presented herein. Various embodiments of process 700 are also discussed in conjunction with FIGS. 2A and 3A. Method 700 begins, after a start block, at block 702, where the backbone model is employed to generate a backbone feature vector for a first image of a set of image-level labeled images. At block 704, the set of image-level labeled images are employed to train the MLC model. The MLC model generates, based on the backbone feature vector for the first image, a first set of object proposals. The first set of object proposals may be for one or more objects depicted in the first image. The first set of object proposals may include at least one of a first set of object bounding boxes, a first set of weights corresponding to the first set of object bounding boxes, and/or a first set of instance segmentation masks for the one or more objects depicted in the first image. Each instance segmentation mask included in the first set of instance segmentation masks may include one or more sets of pixel-wise labels for the first image. The first set of object proposals may be an initial set of object proposals.

At block 706, the first set of object proposals are employed to train the OD model. The OD model generates, based on the backbone feature vector for the first image, a second set of object proposals. The second set of object proposals may be for the one or more objects depicted in the first image. The second set of object proposals may include at least one of a second set of object bounding boxes, a second set of weights corresponding to the second set of object bounding boxes, and/or a second set of instance segmentation masks for the one or more objects depicted in the first image. Each instance segmentation mask included in the second set of instance segmentation masks may include one or more sets of pixel-wise labels for the first image.

At block 708, the second set of object proposals are employed to train the IR model. The IR model generates, based on the backbone feature vector for the first image, a third set of object proposals. The third set of object proposals may be for the one or more objects depicted in the first image. The third set of object proposals may include at least one of a third set of object bounding boxes, a third set of weights corresponding to the third set of object bounding boxes, and/or a third set of instance segmentation masks for the one or more objects depicted in the first image. Each instance segmentation mask included in the third set of instance segmentation masks may include one or more sets of pixel-wise labels for the first image.

At block 710, the third set of object proposals are employed to train the IS model. The IS model generates, based on the backbone feature vector for the first image, a fourth set of object proposals. The fourth set of object proposals may be for the one or more objects depicted in the first image. The fourth set of object proposals may include at least one of a fourth set of object bounding boxes, a fourth set of weights corresponding to the fourth set of object bounding boxes, and/or a fourth set of instance segmentation masks for the one or more objects depicted in the first image. Each instance segmentation mask included in the fourth set of instance segmentation masks may include one or more sets of pixel-wise labels for the first image. The fourth set of instance segmentation masks may include another instance segmentation mask for the first image. The fourth set of object proposals may be a final set of object proposals for the first image.

FIG. 7B illustrates one embodiment of an enhanced process flow 720 for backwards-validation of an image segmentation engine (ISE) that is consistent with the various embodiments presented herein. Various embodiments of process 740 are also discussed in conjunction with FIGS. 2B and 3B. Method 720 begins, after a start block, at block 722, where the backbone model is employed to generate a backbone feature vector for a second image of the set of image-level labeled images. At block 724, the IS model is employed to generate, based on the backbone feature vector for the second image, a fifth set of object proposals. The fifth set of object proposals may be for one or more objects depicted in the second image. The fifth set of object proposals may include at least one of a fifth set of object bounding boxes, a fifth set of weights corresponding to the fifth set of object bounding boxes, and/or a fifth set of instance segmentation masks for the one or more objects depicted in the second image. Each instance segmentation mask included in the fifth set of instance segmentation masks may include one or more sets of pixel-wise labels for the second image. The fifth set of instance segmentation masks may include a final instance segmentation mask for the second image. The fifth set of object proposals may be a final set of object proposals for the second image.

At block 726, the fifth set of object proposals are employed to validate the training of the IR model. The IR model generates, based on the backbone feature vector for the second image, a sixth set of object proposals. The sixth set of object proposals may be for the one or more objects depicted in the second image. The sixth set of object proposals may include at least one of a sixth set of object bounding boxes, a sixth set of weights corresponding to the sixth set of object bounding boxes, and/or a sixth set of instance segmentation masks for the one or more objects depicted in the second image. Each instance segmentation mask included in the sixth set of instance segmentation masks may include one or more sets of pixel-wise labels for the second image.

At block 728, the sixth set of object proposals are employed to validate the training of the OD model. The OD model generates, based on the backbone feature vector for the second image, a seventh set of object proposals. The seventh set of object proposals may be for the one or more objects depicted in the second image. The seventh set of object proposals may include at least one of a seventh set of object bounding boxes, a seventh set of weights corresponding to the sixth set of object bounding boxes, and/or a seventh set of instance segmentation masks for the one or more objects depicted in the second image. Each instance segmentation mask included in the seventh set of instance segmentation masks may include one or more sets of pixel-wise labels for the second image.

At block 730, the seventh set of object proposals are employed to validate the training of the MCL model. The MCL model generates, based on the backbone feature vector for the second image, an eighth set of object proposals. The eighth set of object proposals may be for the one or more objects depicted in the second image. The eighth set of object proposals may include at least one of an eighth set of object bounding boxes, an eighth set of weights corresponding to the sixth set of object bounding boxes, and/or an eighth set of instance segmentation masks for the one or more objects depicted in the second image. Each instance segmentation mask included in the eighth set of instance segmentation masks may include one or more sets of pixel-wise labels for the second image.

### Examples of Instance Segmentation via the Various Enhanced Embodiments

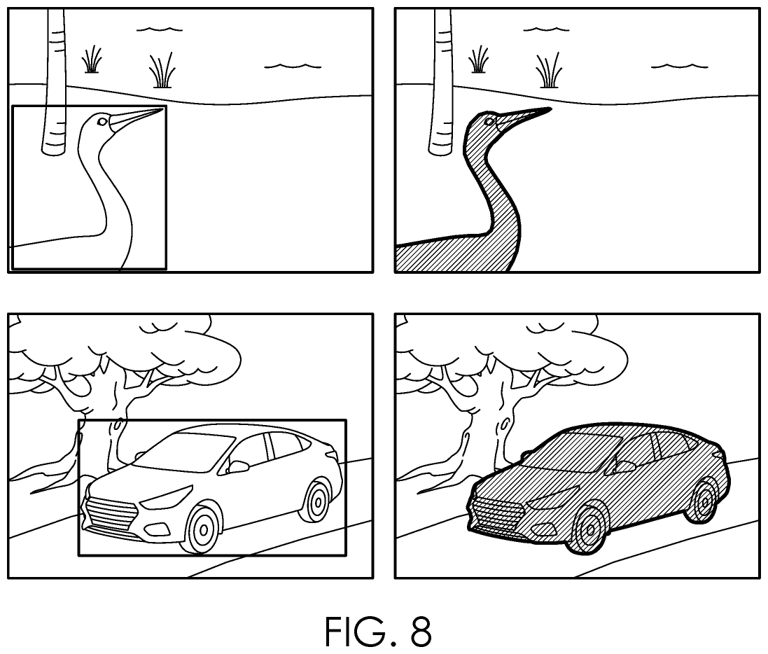

FIG. 8 illustrates various examples of instance segmentations performed by the various embodiments. The images shown in FIG. 8 come in pairs, where the first image in the pair shows one or more bounding boxes, along with the corresponding weight, where the bounding boxes and weights correspond to a classified object in the image. The second image in the pair illustrates (e.g., via shades/colors/highlights) the pixels that contribute to the classified object.

### Illustrative Computing Device

Having described embodiments of the present invention, an example operating environment in which embodiments of the present invention may be implemented is described below in order to provide a general context for various aspects of the present invention. Referring to FIG. 9, an illustrative operating environment for implementing embodiments of the present invention is shown and designated generally as computing device 900. Computing device 900 is but one example of a suitable computing environment and is not intended to suggest any limitation as to the scope of use or functionality of the invention. Neither should the computing device 900 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a smartphone or other handheld device. Generally, program modules, or engines, including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialized computing devices, etc. Embodiments of the invention may also be practiced in distributed computing environments where tasks are performed by remote-processing devices that are linked through a communications network.

With reference to FIG. 9, computing device 900 includes a bus 910 that directly or indirectly couples the following devices: memory 912, one or more processors 914, one or more presentation components 916, input/output ports 918, input/output components 920, and an illustrative power supply 922. Bus 910 represents what may be one or more busses (such as an address bus, data bus, or combination thereof). Although the various blocks of FIG. 9 are shown with clearly delineated lines for the sake of clarity, in reality, such delineations are not so clear and these lines may overlap. For example, one may consider a presentation component such as a display device to be an I/O component, as well. Also, processors generally have memory in the form of cache. We recognize that such is the nature of the art, and reiterate that the diagram of FIG. 9 is merely illustrative of an example computing device that can be used in connection with one or more embodiments of the present disclosure. Distinction is not made between such categories as “workstation,” “server,” “laptop,” “hand-held device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer storage media in the form of volatile and/or nonvolatile memory. Memory 912 may be non-transitory memory. As depicted, memory 912 includes instructions 924. Instructions 924, when executed by processor(s) 914 are configured to cause the computing device to perform any of the operations described herein, in reference to the above discussed figures, or to implement any program modules described herein. The memory may be removable, non-removable, or a combination thereof. Illustrative hardware devices include solid-state memory, hard drives, optical-disc drives, etc. Computing device 900 includes one or more processors that read data from various entities such as memory 912 or I/O components 920. Presentation component(s) 916 present data indications to a user or other device. Illustrative presentation components include a display device, speaker, printing component, vibrating component, etc.

I/O ports 918 allow computing device 900 to be logically coupled to other devices including I/O components 920, some of which may be built in. Illustrative components include a microphone, joystick, game pad, satellite dish, scanner, printer, wireless device, etc.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

From the foregoing, it will be seen that this disclosure in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in a limiting sense, and the scope of embodiments is defined by the appended claims and their equivalents.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A non-transitory computer-readable storage medium having instructions stored thereon for segmenting object instances based on an image segmentation engine that implements a multi-label classification model, an object detection model, an instance refinement model, and an instance segmentation model, which, when executed by a processor of a computing device cause the computing device to perform actions comprising:
employing a set of image-level labeled images to supervise a training of the multi-label classification model that generates, based on a first image of the set of image-level labeled images, a first set of object bounding boxes and a first set of weights that corresponds to the first set of object bounding boxes;
employing the first set of object bounding boxes and the first set of weights to supervise a training of object detection model that generates, based on the first image, a second set of instance segmentation masks, a second set of object bounding boxes that corresponds to the second set of instance segmentation masks, and a second set of weights that corresponds to the second set of object bounding boxes;
employing the second set of instance segmentation masks, the second set of object bounding boxes, and the second set of weights to supervise a training of the instance refinement model implemented that generates, based on the first image, a third set of instance segmentation masks, a third set of object bounding boxes that corresponds to the third set of instance segmentation masks, and a third set of weights that corresponds to the third set of object bounding boxes;
employing the third set of instance segmentation masks, the third set of object bounding boxes, and the third set of weights to supervise a training of the instance segmentation model that generates a segmentation mask for the first image that includes a set of pixel-wise labels for the first image; and
segmenting an object instance from a new image based on the image segmentation engine.

2. The computer-readable storage medium of claim 1, the actions further comprising:
employing the instance segmentation model to generate, based a second image of the set of image-level labeled images, a fifth set of object bounding boxes and a fifth set of weights that correspond to the fifth set of object bounding boxes;
employing a fifth set of instance segmentation masks, the fifth set of object bounding boxes, and the fifth set of weights to validate the training of the instance refinement model that generates, based on the second image, a sixth set of instance segmentation masks, a sixth set of object bounding boxes corresponding to the sixth set of instance segmentation masks, and a sixth set of weights corresponding to the sixth set of object bounding boxes;
employing the sixth set of instance segmentation masks, the sixth set of object bounding boxes, and the sixth set of weights to validate the training of the object detection model that generates, based on the second image, a seventh set of object bounding boxes and a seventh set of weights corresponding to the seventh set of object bounding boxes; and
employing the seventh set of object bounding boxes and the seventh set of weights to validate the training of the multi-label classification model.

3. The computer-readable storage medium of claim 1, where the actions further comprise:
employing at least a portion of the set of image-level labeled images to pre-train the multi-label classification model based on an initialization of the multi-label classification model;
employing output of the pre-trained multi-label classification model to pre-train the object detection model;
employing output of the pre-trained object detection model to pre-train the instance refinement model; and
employing output of the pre-trained instance refinement model to pre-train the instance segmentation model.

4. The computer-readable storage medium of claim 1, wherein the actions further comprise:
employing a backbone model implemented by the image segmentation engine to generate a feature vector based on the first image;
employing the feature vector as input to the multi-label classification model to generate the first set of object bounding boxes and the first set of weights;
employing the feature vector as input to the object detection model to generate the second set of instance segmentation masks, the second set of object bounding boxes, and the second set of weights;
employing the feature vector as input to the instance refinement model to generate the third set of instance segmentation masks, the third set of object bounding boxes, and the third set of weights; and
employing the feature vector as input to the instance segmentation model to generate the segmentation mask for the first image.

5. The one or more computer-readable storage media of claim 1, wherein the actions further comprise:
generating a set of proposal attention maps based on the first set of object bounding boxes and the first set of weights;
generating an instance attention map based on the set of proposal attention maps; and
generating a first set of instance segmentation masks based on the instance attention map.

6. The one or more computer-readable storage media of claim 1, wherein the actions further comprise:
employing a non-maximum suppression algorithm to suppress a subset of the first set of object bounding boxes; and
generating an instance attention map based on the suppressed subset of the first set of object bounding boxes.

7. The one or more computer-readable storage media of claim 1, wherein the set of image-level labeled images excludes pixel-wise labels.

8. A method for training an image segmentation engine that implements a multi-label classification model, an object detection model, an instance refinement model, and an instance segmentation model, comprising:
employing a set of image-level labeled images to supervise a training of the multi-label classification model that generates, based on a first image of the set of image-level labeled images, a first set of object bounding boxes and a first set of weights that corresponds to the first set of object bounding boxes;
employing the first set of object bounding boxes and the first set of weights to supervise a training of object detection model that generates, based on the first image, a second set of instance segmentation masks, a second set of object bounding boxes that corresponds to the second set of instance segmentation masks, and a second set of weights that correspond to the second set of object bounding boxes;
employing the second set of instance segmentation masks, the second set of object bounding boxes, and the second set of weights to supervise a training of the instance refinement model implemented that generates, based on the first image, a third set of instance segmentation masks, a third set of object bounding boxes that corresponds to the third set of instance segmentation masks, and a third set of weights that correspond to the third set of object bounding boxes; and
employing the third set of instance segmentation masks, the third set of object bounding boxes, and the third set of weights to supervise a training of the instance segmentation model that generates a segmentation mask for the first image that includes a set of pixel-wise labels for the first image.

9. The method for claim 8, further comprising:
employing the instance segmentation model to generate, based a second image of the set of image-level labeled images, a fifth set of object bounding boxes and a fifth set of weights that correspond to the fifth set of object bounding boxes;
employing a fifth set of instance segmentation masks, the fifth set of object bounding boxes, and the fifth set of weights to validate the training of the instance refinement model that generates, based on the second image, a sixth set of instance segmentation masks, a sixth set of object bounding boxes corresponding to the sixth set of instance segmentation masks, and a sixth set of weights corresponding to the sixth set of object bounding boxes;
employing the sixth set of instance segmentation masks, the sixth set of object bounding boxes, and the sixth set of weights to validate the training of the object detection model that generates, based on the second image, a seventh set of object bounding boxes and a seventh set of weights corresponding to the seventh set of object bounding boxes; and
employing the seventh set of object bounding boxes and the seventh set of weights to validate the training of the multi-label classification model.

10. The method of claim 8, further comprising:
employing at least a portion of the set of image-level labeled images to pre-train the multi-label classification model based on an initialization of the multi-label classification model;
employing output of the pre-trained multi-label classification model to pre-train the object detection model;
employing output of the pre-trained object detection model to pre-train the instance refinement model; and
employing output of the pre-trained instance refinement model to pre-train the instance segmentation model.

11. The method of claim 8, further comprising:
employing a backbone model implemented by the image segmentation engine to generate a feature vector based on the first image;
employing the feature vector as input to the multi-label classification model to generate the first set of object bounding boxes and the first set of weights;
employing the feature vector as input to the object detection model to generate the second set of instance segmentation masks, the second set of object bounding boxes, and the second set of weights;
employing the feature vector as input to the instance refinement model to generate the third set of instance segmentation masks, the third set of object bounding boxes, and the third set of weights; and
employing the feature vector as input to the instance segmentation model to generate the segmentation mask for the first image.

12. The method of claim 8, further comprising:
generating a set of proposal attention maps based on the first set of object bounding boxes and the first set of weights;
generating an instance attention map based on the set of proposal attention maps; and
generating a first set of instance segmentation masks based on the instance attention map.

13. The method of claim 8, further comprising:
employing a non-maximum suppression algorithm to suppress a subset of the first set of object bounding boxes; and
generating an instance attention map based on the suppressed subset of the first set of object bounding boxes.

14. The method of claim 8, wherein the set of image-level labeled images excludes pixel-wise labels.

15. A computing system, comprising:
a processor device; and
a computer-readable storage medium, coupled with the processor device, having instructions stored thereon, which, when executed by the processor device, train an image segmentation engine that implements a multi-label classification model, an object detection model, an instance refinement model, and an instance segmentation model, by performing actions comprising:
employing a set of image-level labeled images to supervise a training of the multi-label classification model that generates, based on a first image of the set of image-level labeled images, a first set of object bounding boxes and a first set of weights that corresponds to the first set of object bounding boxes;
employing the first set of object bounding boxes and the first set of weights to supervise a training of object detection model that generates, based on the first image, a second set of instance segmentation masks, a second set of object bounding boxes that corresponds to the second set of instance segmentation masks, and a second set of weights that correspond to the second set of object bounding boxes;
employing the second set of instance segmentation masks, the second set of object bounding boxes, and the second set of weights to supervise a training of the instance refinement model implemented that generates, based on the first image, a third set of instance segmentation masks, a third set of object bounding boxes that corresponds to the third set of instance segmentation masks, and a third set of weights that correspond to the third set of object bounding boxes; and
employing the third set of instance segmentation masks, the third set of object bounding boxes, and the third set of weights to supervise a training of the instance segmentation model that generates a segmentation mask for the first image that includes a set of pixel-wise labels for the first image.

16. The computing system of claim 15, the actions further comprising:
employing the instance segmentation model to generate, based a second image of the set of image-level labeled images, a fifth set of object bounding boxes and a fifth set of weights that correspond to the fifth set of object bounding boxes;
employing a fifth set of instance segmentation masks, the fifth set of object bounding boxes, and the fifth set of weights to validate the training of the instance refinement model that generates, based on the second image, a sixth set of instance segmentation masks, a sixth set of object bounding boxes corresponding to the sixth set of instance segmentation masks, and a sixth set of weights corresponding to the sixth set of object bounding boxes;
employing the sixth set of instance segmentation masks, the sixth set of object bounding boxes, and the sixth set of weights to validate the training of the object detection model that generates, based on the second image, a seventh set of object bounding boxes and a seventh set of weights corresponding to the seventh set of object bounding boxes; and
employing the seventh set of object bounding boxes and the seventh set of weights to validate the training of the multi-label classification model.

17. The computing system of claim 15, the actions further comprising:
employing at least a portion of the set of image-level labeled images to pre-train the multi-label classification model based on an initialization of the multi-label classification model;
employing output of the pre-trained multi-label classification model to pre-train the object detection model;
employing output of the pre-trained object detection model to pre-train the instance refinement model; and
employing output of the pre-trained instance refinement model to pre-train the instance segmentation model.

18. The computing system of claim 15, the actions further comprising:
employing a backbone model implemented by the image segmentation engine to generate a feature vector based on the first image;
employing the feature vector as input to the multi-label classification model to generate the first set of object bounding boxes and the first set of weights;
employing the feature vector as input to the object detection model to generate the second set of instance segmentation masks, the second set of object bounding boxes, and the second set of weights;
employing the feature vector as input to the instance refinement model to generate the third set of instance segmentation masks, the third set of object bounding boxes, and the third set of weights; and
employing the feature vector as input to the instance segmentation model to generate the segmentation mask for the first image.

19. The computing system of claim 18, the actions further comprising:
generating a set of proposal attention maps based on the first set of object bounding boxes and the first set of weights;
generating an instance attention map based on the set of proposal attention maps; and
generating a first set of instance segmentation masks based on the instance attention map.

20. The computing system of claim 15, the actions further comprising:
employing a non-maximum suppression algorithm to suppress a subset of the first set of object bounding boxes; and
generating an instance attention map based on the suppressed subset of the first set of object bounding boxes.
